(19) United States
(12) Patent Application Publication
(10) Pub. No.: US 2024/0257035 A1
(43) Pub. Date: Aug. 1, 2024

(54) SYSTEMS AND METHODS FOR DRIVER PLATFORM ANALYSIS

(71) Applicant: Walmart Apollo, LLC, Bentonville, AR (US)

(72) Inventors: Tao Cao, San Bruno, CA (US); Soumita Saha, Kolkata (IN); Minghui Liu, San Bruno, CA (US); Chenxin Ma, Belmont, CA (US); Yuan Wang, San Francisco, CA (US); Jing Huang, San Jose, CA (US); Mingang Fu, Palo Alto, CA (US)

(73) Assignee: Walmart Apollo, LLC, Bentonville, AR (US)

(21) Appl. No.: 18/427,636

(22) Filed: Jan. 30, 2024

Related U.S. Application Data
(60) Provisional application No. 63/442,020, filed on Jan. 30, 2023.

(51) Int. Cl. G06Q 10/0834; G06Q 10/0631; G06Q 10/083

(52) U.S. Cl. CPC G06Q 10/0834; G06Q 10/06311; G06Q 10/0838

(57) ABSTRACT

Systems and methods including one or more processors and one or more non-transitory storage devices storing computing instructions configured to run on the one or more processors and perform: receiving historical driver search information corresponding to a first offer publish time criterion, the first offer publish criterion including a driver lag time; building a machine learning model based on the driver search information to determine a first metric and a second metric; analyzing the first metric and the second metric with an optimization model to determine a second offer publish time criterion that reduces the driver lag time; receiving an order for a delivery for an item, the order including a delivery time window; transmitting the order to a driver search platform subject to the second offer publish time criterion to reduce the driver lag time and mitigate delivery outside of the delivery time window. Other embodiments are disclosed herein.

### CROSS-REFERENCE TO RELATED APPLICATIONS

This application claims priority to U.S. Provisional Patent Application No. 63/442,020, filed Jan. 30, 2023. U.S. Provisional Patent Application No. 63/442,020 is incorporated herein by reference in its entirety.

### TECHNICAL FIELD

This disclosure relates generally to computing system management, and more particular to systems and methods for driver platform analysis.

### BACKGROUND

Marketplaces are responsible for millions of products at a time. In addition to managing the millions of products in the marketplace, an owner of the marketplace may be responsible for the packaging and delivery of these products. In particular, the owner has to determine an optimized publish time for packages to enable the products to be delivered safely and on time. However, a number of issues need to be managed relating to publishing pick-up times, loading parcels, packages, and/or other items into a delivery truck, a shipping container, and/or the like.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIG. 3;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 illustrates a flowchart for a method, according to certain embodiments;

FIG. 5 illustrates an example timeline comparing driver lag time, driver search time and drive to store time, according to certain embodiments;

FIG. 6 illustrates an exemplary decision tree, according to certain embodiments; and

FIG. 7 illustrates an exemplary system architecture that can be used to train a machine learning model, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

A number of embodiments can include a system. The system can include one or more processors and one or more non-transitory computer-readable storage devices storing computing instructions. The computing instructions can be configured to run on the one or more processors and cause the one or more processors to perform: receiving historical driver search information corresponding to a first offer publish time criterion, the first offer publish criterion including a driver lag time; building a machine learning model based on the driver search information to determine a first metric and a second metric; analyzing the first metric and the second metric with an optimization model to determine a second offer publish time criterion that reduces the driver lag time; receiving an order for a delivery for an item, the order including a delivery time window; transmitting the order to a driver search platform subject to the second offer publish time criterion to reduce the driver lag time and mitigate delivery outside of the delivery time window.

Various embodiments include a method. The method can be implemented via execution of computing instructions configured to run at one or more processors and configured to be stored at non-transitory computer-readable media. The method can comprise receiving historical driver search information corresponding to a first offer publish time criterion, the first offer publish criterion including a driver lag time; building a machine learning model based on the driver search information to determine a first metric and a second metric; analyzing the first metric and the second metric with an optimization model to determine a second offer publish time criterion that reduces the driver lag time; receiving an order for a delivery for an item, the order including a delivery time window; transmitting the order to a driver search platform subject to the second offer publish time criterion to reduce the driver lag time and mitigate delivery outside of the delivery time window.

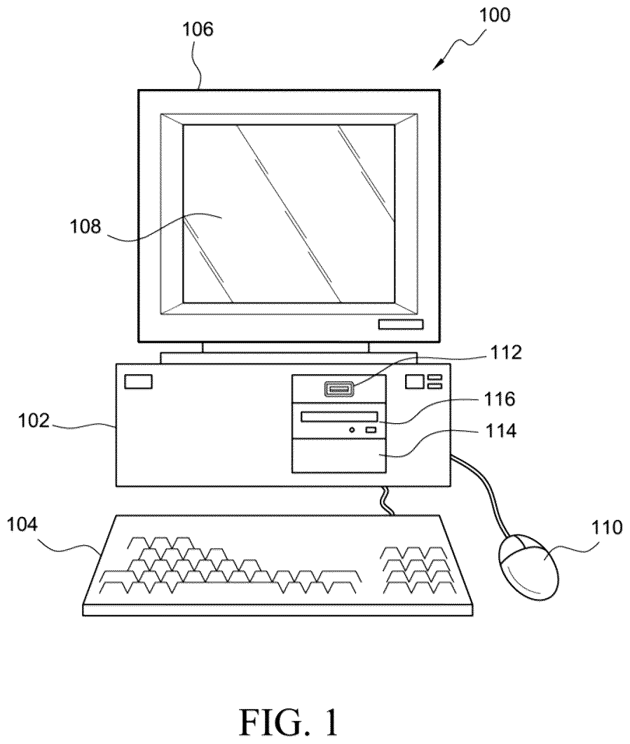

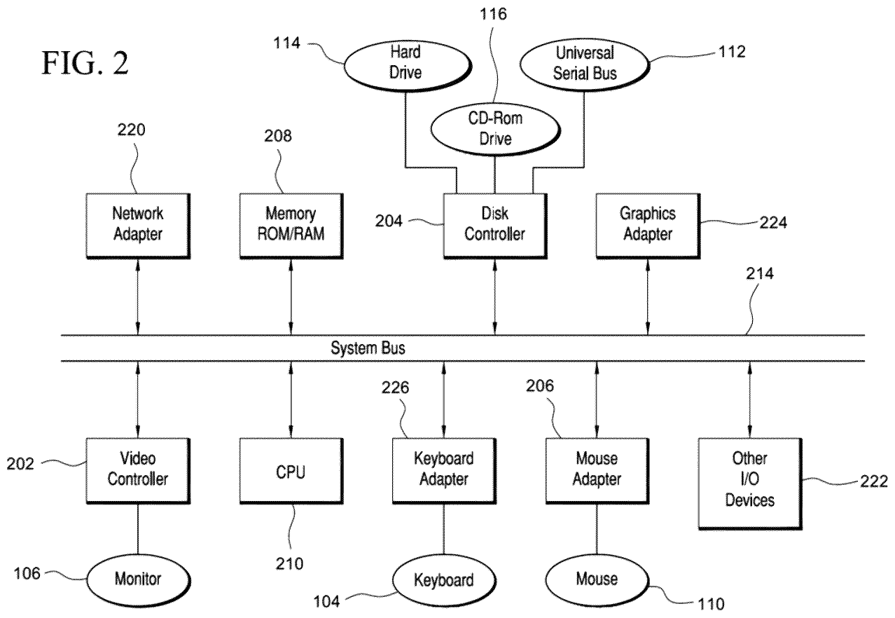

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

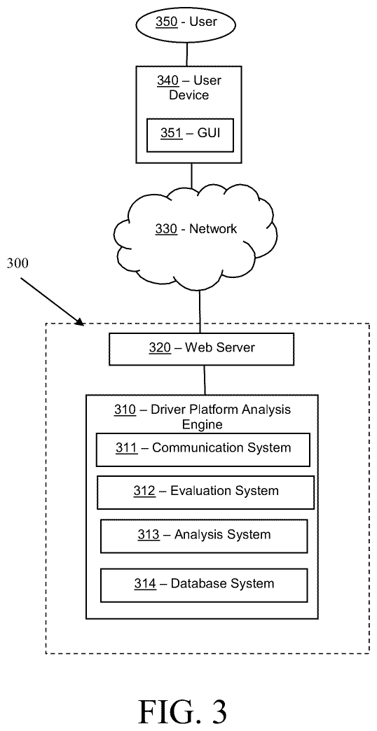

Turning ahead in the drawings, FIG. 3 illustrates a block diagram of a system 300 that can be employed for driver platform analysis, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a driver platform analysis engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Driver platform analysis engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host driver platform analysis engine 310 and/or web server 320. Additional details regarding driver platform analysis engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with infrastructure components in an IT environment, in addition to other suitable activities. In a number of embodiments, web server 320 can interface with driver platform analysis engine 310 when a user (e.g., 350) is viewing infrastructure components in order to assist with the analysis of the infrastructure components. In some embodiments, an internal network that is not open to the public can be used for communications between driver platform analysis engine 310 and web server 320 within system 300. Accordingly, in some embodiments, driver platform analysis engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, driver platform analysis engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to driver platform analysis engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of driver platform analysis engine 310 and/or web server 320. In a similar manner, the processors and/or the non-transitory computer-readable media can be local and/or remote to each other.

Meanwhile, in many embodiments, driver platform analysis engine 310 and/or web server 320 also can be configured to communicate with one or more databases, such as a database system 314. The one or more databases can include historical driver search information, delivery information, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, driver platform analysis engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, driver platform analysis engine 310 can include a communication system 311, an evaluation system 312, an analysis system 313, and/or database system 314. In many embodiments, the systems of driver platform analysis engine 310 can be modules of computing instructions (e.g., software modules) stored at non-transitory computer readable media that operate on one or more processors. In other embodiments, the systems of driver platform analysis engine 310 can be implemented in hardware. Driver platform analysis engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host driver platform analysis engine 310 and/or web server 320. Additional details regarding driver platform analysis engine 310 and the components thereof are described herein.

In many embodiments, user device 340 can comprise graphical user interface (“GUI”) 351. In the same or different embodiments, GUI 351 can be part of and/or displayed by user computer 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user computers 340. In the same or different embodiments, GUI 351 can comprise a website accessed through internet 320. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network (e.g., Internet) 330 with user computers (e.g., 340). In certain embodiments, user computers 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, driver platform analysis engine 310, and/or web server 320 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of driver platform analysis engine 310, and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of driver platform analysis engine 310, and/or web server 320. In a similar manner, the processing module(s) and the memory storage module(s) can be local and/or remote to each other.

In many embodiments, driver platform analysis engine 310, and/or web server 320 can be configured to communicate with one or more user computers 340. In some embodiments, user computers 340 also can be referred to as customer computers. In some embodiments, driver platform analysis engine 310, and/or web server 320 can communicate or interface (e.g., interact) with one or more customer computers (such as user computers 340) through a network or internet 330. Internet 330 can be an intranet that is not open to the public. In further embodiments, Internet 330 can be a mesh network of individual systems. Accordingly, in many embodiments, driver platform analysis engine 310, and/or web server 320 (and/or the software used by such systems) can refer to a back end of system 300 operated by an operator and/or administrator of system 300, and user computers 340 (and/or the software used by such systems) can refer to a front end of system 300 used by one or more users 350, respectively. In some embodiments, users 350 can also be referred to as customers, in which case, user computers 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

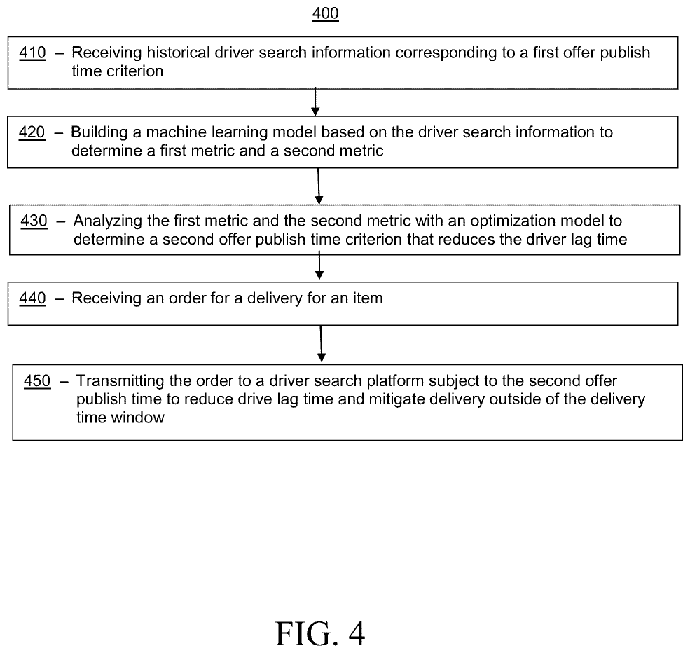

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as driver platform analysis engine 310, web server 320, and/or user device 340 (FIG. 3). The processing module(s) can be similar or identical to the processing module(s) described above with respect to computer system 100 (FIG. 1).

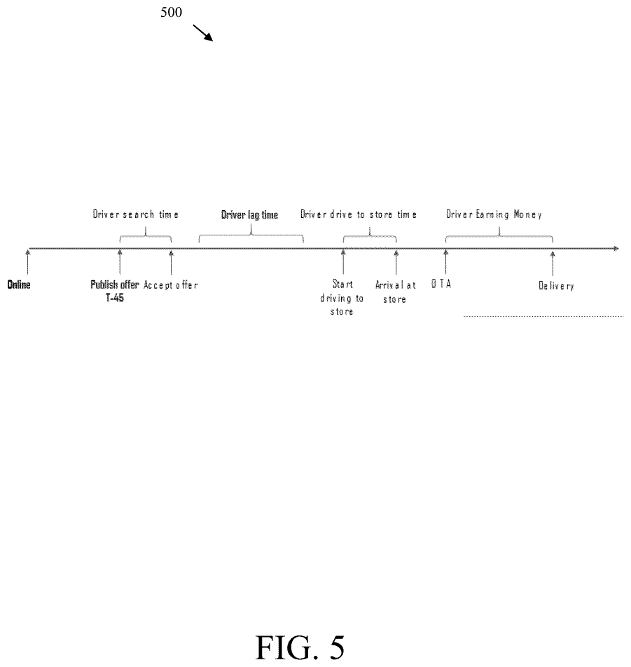

In many embodiments, method 400 can comprise an activity 410 of receiving historical driver search information corresponding to a first offer publish time criterion. In some embodiments, the historical driver search information includes at least: offer characteristics, environment setting, a publish offer time corresponding to the first offer publish time criterion, driver search time (ST), an offer acceptance time (e.g., timestamp of when driver accepted offer), driver lag time, drive to store time (DST), arrival at store time, on time arrival (OTA), and delivery time. In some embodiments, the offer characteristics can include a delivery priority such as express, regular, or deliver today. In some embodiments, the environment settings can include a day of the week, and an hour of the day corresponding to when an item is to be delivered. In some embodiments, a publish offer time corresponds to a time at which an order that needs to be delivered is published to drivers based on a driver selection process. In some embodiments, driver search time corresponds to the amount of time between the offer publish time and when a driver accepts the published offer. In some embodiments, driver lag time corresponds to an amount of time between the offer acceptance time and the start of the drive to store time. For example, a driver may accept an offer at 1:00 PM and can start driving to the store at 1:30 PM resulting in a driver lag time of 30 minutes. In some embodiments, OTA corresponds to a start time of when the driver is en route to a delivery destination that will result in a delivery inside of a time window for an order. For example, an order can have a delivery window between 5:00 PM-6:00 PM and the OTA can start at 5:15 PM resulting in the delivery to occur on time. In some embodiments, the first offer publish time criterion is determined by identifying start time of a delivery time window, and identifying a time forty five minutes prior to the start of the delivery time window. For example, an order can be received and the order can identify a delivery time window between 5:00 PM-6:00 PM. As such, the start time of the delivery window is 5:00 PM. In this example, the offer publish time criterion is 45 minutes before the start time of the delivery window. However, this static offer publish criterion can result in significant driver lag time. Turning briefly to FIG. 5, an example timeline 500 is illustrated that shows how the static offer publish criteria can result in driver lag time between the driver search time and the drive to store time. This results in a waste of resources because the driver may not be actively engaged in a delivery during this time, and the driver lag time can create bottlenecks in other areas of the system because a driver that is available to handle this order may be mitigated from handling this order because another driver has accepted the order, even though it will result in lag time. To mitigate driver lag time, embodiments, disclosed herein build, train, and utilize machine learning and optimization models as discussed in more detail below.

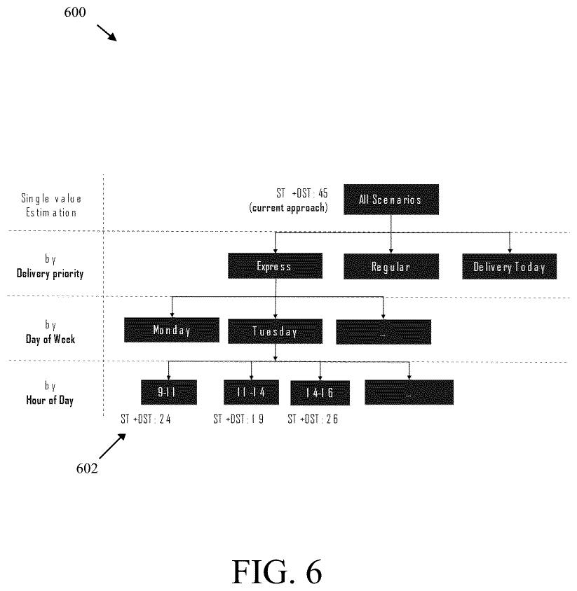

Returning to FIG. 4, in many embodiments method 400 can comprise an activity 420 of building a machine learning model based on the driver search information to determine a first metric and a second metric. In some embodiments, the first metric is the driver search time, and the second metric is the drive to store time. In some embodiments, activity 420 can include analyzing the historical driver search information to identify a delivery priority from the offer characteristics. For example, activity 420 can include analyzing the previously executed delivery orders and identifying the delivery priority such as express, regular, or deliver today associated with each delivery order. In some embodiments, activity 420 can include analyzing the historical driver search information to identify a day of the week and an hour of the day from the environment settings. For example, activity 420 can include analyzing the previously executed delivery orders and identifying the day of the week and the hour of the day associated with each delivery order. In some embodiments, activity 420 can include building a decision tree that includes a first level corresponding to the delivery priority, a second level corresponding to the day of the week, and a third level that corresponds to the hour of the day. In some embodiments, activity 420 can include determining an output from the decision tree as a combination of the driver search time (ST) and the drive to store time (DST). In some embodiments, the output corresponds to a total time for the driver search time and the drive to store time. Turning briefly to FIG. 6, an exemplary decision tree 600 is illustrated. In the illustrated embodiment of FIG. 6, an example output 602 is illustrated which shows that a total time for the driver search time and the drive to store time for an express delivery on Tuesday between 9:00 AM-11:00 AM is 24 minutes. The output 602 is a dynamic time based on historical information and can reduce driver lag time. In contrast, the static output of 45 minutes often increases driver lag time.

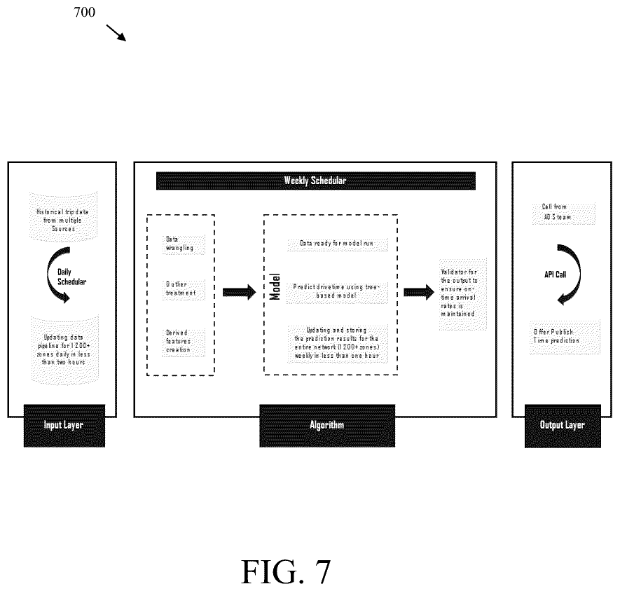

Returning to FIG. 4, activity 420 can include training the machine learning model to reduce lag time from the historical driver search information and to maintain an on time arrival within 90%. For example, the machine learning model can analyze the historical driver search information to determine outputs (e.g., output 602) that result in a reduction of driver lag time and still maintain between an 80%-95% OTA. This ensures that the reduction in driver lag time does not result in deliveries well outside of a delivery time window. Turning briefly to FIG. 7, an exemplary system architecture 700 is illustrated that can be used to train the machine learning model.

Returning to FIG. 4, in many embodiments, method 400 can comprise an activity 430 of analyzing the first metric and the second metric with an optimization model to determine a second offer publish time criterion that reduces the driver lag time. In some embodiments, analyzing the first metric and the second metric with the optimization model can include minimizing Z subject to the following equation:

$$P ( X + Y < Z ) \geq 0.9$$

$$X + Y ∼ N ( {μ}_{x} + {μ}_{y} , {σ}_{x}^{2} + {σ}_{y}^{2} + 2 {σ}_{x , y} )$$

where Z corresponds to a decision variable for offer publish time, X˜N(μₓ, σₓ²) corresponds to a random variable of driver search time, Y˜N(μ_{y}, σ_{y}³) corresponds to a random variable of drive to store time, and μₓ, μ_{y}, σₓ², σ_{y}², σ_{x,y}² correspond to estimated parameters from the decision tree. For example, the estimated parameters can come from the output (e.g., output 602) of the decision tree of the machine learning model.

In some embodiments, the second offer publish time criterion can reduce the driver lag time by publishing an offer for an order dynamically. For example, the optimization model can minimize Z subject to the parameters from the output 602 (FIG. 6) to determine that the publish criterion should be 25 minutes instead of the static 45 minutes. As such, the second offer publish criterion can reduce driver lag time by 20 minutes.

In many embodiments, method 400 can comprise an activity 440 of receiving an order for a delivery for an item. In some embodiments, the order can include a delivery time window. For example, an order can be received for a delivery to be executed between 5:00 PM-6:00 PM. In some embodiments, the offer characteristics and environment settings for the order can be processed utilizing activities 410-430 to determine a dynamic offer publish time criterion. In some embodiments, activities 410-430 can determine that an updated offer publish criterion is 25 minutes. That is, the offer to execute this order should be published 25 minutes before the start of the delivery window.

In many embodiments, method 400 can comprise an activity 450 of transmitting the order to a driver search platform subject to the second offer publish time criterion to reduce the driver lag time and mitigate delivery outside of the delivery time window. In some embodiments, transmitting the order to the driver search platform subject to the second offer publish time criterion can include processing the delivery time window to determine a start time for the delivery time window. For example, the delivery window can be between 5:00 PM-6:00 PM and the start time can be 5:00 PM. In some embodiments, activity 450 can include identifying a driver selection process based on the start time for the delivery time window. For example, the driver selection process is a round robin selection process. In some embodiments, the round robin selection process can access a ranked list of drivers and select a driver profile and transmit a delivery offer to the selected driver profile. If the driver does not accept the offer, the round robin selection process selects a next-ranked driver profile and transmits the delivery offer to the selected driver profile. In some embodiments, the round robin selection process can implement a group-specific selection processes configured to select drivers within predetermined segmented groups. For example, in various embodiments, the round robin selection process can include a group of preferred drivers, a group of secondary drivers, a group of third-party deliverers, and/or any other suitable group of drivers. The round robin selection process may be configured to select a first percentage of drivers from a first group, a second percentage of drivers from a second group, a third percentage of drivers from a third group, etc. In some embodiments, the round robin selection process can be based on one or more driver parameters and/or order parameters, such as, for example, driver availability, driver trips completed, driver rejection preference, order slot, source location, and/or one or more driver/order parameters.

Returning to FIG. 3, in several embodiments, communication system 311 can at least partially perform activity 410 (FIG. 4), and/or activity 440 (FIG. 4).

In several embodiments, evaluation system 312 can at least partially perform activity 420 (FIG. 4), and/or activity 430 (FIG. 4).

In a number of embodiments, analysis system 313 can at least partially perform activity 450 (FIG. 4).

In a number of embodiments, web server 320 can at least partially perform method 400.

As presented herein, various embodiments disclose a driver search timing decision service that can determine an offer publish time and remaining stages of the process in a dynamic and more optimal manner in an environment where the demand is scheduled, instead of generated in real-time. The embodiments of the systems and methods receive orders from customers, process the orders, offer publish time and other time stamps, and releases offers to potential drivers—all to reduce cost per delivery and to also reduce driver lag time, which improves the user experience for drivers and customers.

Moreover, the techniques described herein can solve a technical problem that cannot be solved outside the context of computer networks. Specifically, the techniques described herein cannot be used outside the context of computer networks, in view of a lack of data, and because the driver platform analysis engine cannot be performed without a computer.

In many embodiments, the techniques described herein can provide a practical application and several technological improvements. In some embodiments, the techniques described herein can provide an automatic determination of a set of offer publish times by using a predictive model approach focusing on a reduction in driver lag time based on at least a machine learning approach. These techniques described herein can provide a significant improvement over conventional approaches of subjectively using a static offer publish time that can expend a lot of time and computer resources, processors, and memory, to compensate for driver lag time.

Further the techniques described herein can advantageously enable real-time data processing and increase the capability to select an offer publish time to maintain an efficiency within a driver search platform.

In many embodiments, the techniques described herein can be used regularly (e.g., hourly, daily, etc.) at a scale that cannot be handled using manual techniques. For example, the system tracks every order and offer publish time that can result in a number that can exceed one hundred million.

Although systems and methods for driver platform analysis have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, perform:
receiving historical driver search information corresponding to a first offer publish time criterion, the first offer publish criterion including a driver lag time;
building a machine learning model based on the driver search information to determine a first metric and a second metric;
analyzing the first metric and the second metric with an optimization model to determine a second offer publish time criterion that reduces the driver lag time;
receiving an order for a delivery for an item, the order including a delivery time window; and
transmitting the order to a driver search platform subject to the second offer publish time criterion to reduce the driver lag time and mitigate delivery outside of the delivery time window.

2. The system of claim 1, wherein the historical driver search information includes at least: offer characteristics, environment setting, a publish offer time corresponding to the first offer publish time criterion, a driver search time (ST), an offer acceptance time, the driver lag time, a drive to store time (DST), an arrival at store time, an on time arrival (OTA), and the delivery time window.

3. The system of claim 1, wherein the first offer publish time criterion is determined by:
identifying a start time for the delivery time window; and
identifying a time forty five minutes prior to the start time for the delivery time window.

4. The system of claim 2, wherein building the machine learning model to determine the first metric and the second metric further comprises:
analyzing the historical driver search information to identify a delivery priority from the offer characteristics;
analyzing the historical driver search information to identify a day of a week and an hour of a day from the environment setting; and
building a decision tree that includes a first level corresponding to the delivery priority, a second level corresponding to the day of the week, and a third level that corresponds to the hour of the day.

5. The system of claim 4, wherein the first metric is the driver search time and the second metric is the drive to store time.

6. The system of claim 5, further comprising determining an output from the decision tree as a combination of the driver search time and the drive to store time, the output corresponding to a total time for the driver search time and the drive to store time.

7. The system of claim 4, further comprising training the machine learning model to reduce lag time from the historical driver search information and to maintain an on time arrival within 90%.

8. The system of claim 1, wherein analyzing the first metric and the second metric with the optimization model to determine the second offer publish time criterion that reduces the driver lag time further comprises:
minimizing Z subject to the following equation:
$$P ( X + Y < Z ) \geq 0.9$$
$$X + Y ∼ N ( {μ}_{x} + {μ}_{y} , {σ}_{x}^{2} + {σ}_{y}^{2} + 2 {σ}_{x , y} )$$
where Z corresponds to a decision variable for offer publish time, X˜N(μₓ, σₓ²) corresponds to a random variable of driver search time, Y˜N(μ_{y}, σ_{y}²) corresponds to a random variable of drive to store time, and μₓ, μ_{y}, σₓ², σ_{y}², σ_{x,y}² correspond to estimated parameters from the decision tree.

9. The system of claim 1, wherein transmitting the order to the driver search platform subject to the second offer publish time criterion to reduce the driver lag time further comprises:
processing the delivery time window to determine a start time for the delivery time window;
identifying a driver selection process based on the start time for the delivery time window;
implementing the driver selection process subject to the second offer publish time criterion.

10. The system of claim 8, wherein the driver selection process is a round robin selection process.

11. A method implemented via execution of computing instructions configured to run at one or more processors and configured to be stored at non-transitory computer-readable media, the method comprising:
receiving historical driver search information corresponding to a first offer publish time criterion, the first offer publish criterion including a driver lag time;
building a machine learning model based on the driver search information to determine a first metric and a second metric;
analyzing the first metric and the second metric with an optimization model to determine a second offer publish time criterion that reduces the driver lag time;
receiving an order for a delivery for an item, the order including a delivery time window; and
transmitting the order to a driver search platform subject to the second offer publish time criterion to reduce the driver lag time and mitigate delivery outside of the delivery time window.

12. The method of claim 11, wherein the historical driver search information includes at least: offer characteristics, environment setting, a publish offer time corresponding to the first offer publish time criterion, a driver search time (ST), an offer acceptance time, the driver lag time, a drive to store time (DST), an arrival at store time, an on time arrival (OTA), and the delivery time window.

13. The method of claim 11, wherein the first offer publish time criterion is determined by:
identifying a start time for the delivery time window; and
identifying a time forty five minutes prior to the start time for the delivery time window.

14. The method of claim 12, wherein building the machine learning model to determine the first metric and the second metric further comprises:
analyzing the historical driver search information to identify a delivery priority from the offer characteristics;
analyzing the historical driver search information to identify a day of a week and an hour of a day from the environment setting; and
building a decision tree that includes a first level corresponding to the delivery priority, a second level corresponding to the day of the week, and a third level that corresponds to the hour of the day.

15. The method of claim 14, wherein the first metric is the driver search time and the second metric is the drive to store time.

16. The method of claim 15, further comprising determining an output from the decision tree as a combination of the driver search time and the drive to store time, the output corresponding to a total time for the driver search time and the drive to store time.

17. The method of claim 14, further comprising training the machine learning model to reduce lag time from the historical driver search information and to maintain an on time arrival within 90%.

18. The method of claim 11, wherein analyzing the first metric and the second metric with the optimization model to determine the second offer publish time criterion that reduces the driver lag time further comprises:
minimizing Z subject to the following equation:
$$P ( X + Y < Z ) \geq 0.9$$
$$X + Y ∼ N ( {μ}_{x} + {μ}_{y} , {σ}_{x}^{2} + {σ}_{y}^{2} + 2 {σ}_{x , y} )$$
where Z corresponds to a decision variable for offer publish time, X˜N(μₓ, σₓ²) corresponds to a random variable of driver search time, Y˜N(μ_{y}, σ_{y}²) corresponds to a random variable of drive to store time, and μₓ, μ_{y}, σₓ², σ_{y}², σ_{x,y}², correspond to estimated parameters from the decision tree.

19. The method of claim 11, wherein transmitting the order to the driver search platform subject to the second offer publish time criterion to reduce the driver lag time further comprises:
processing the delivery time window to determine a start time for the delivery time window;
identifying a driver selection process based on the start time for the delivery time window;
implementing the driver selection process subject to the second offer publish time criterion.

20. The method of claim 18, wherein the driver selection process is a round robin selection process.
